(19) United States
(12) Patent Application Publication
(10) Pub. No.: US 2025/0121327 A1
(43) Pub. Date: Apr. 17, 2025

(54) BATCH-TYPE COMPLEX TEMPERATURE TREATMENT MACHINE USING HIGH-TEMPERATURE PLASMA, AND METHOD FOR TREATING EXHAUST GAS THEREOF

(71) Applicant: Vitzro Nextech Co., LTD., Ansan-si (KR)

(72) Inventors: Byung Ho LEE, Seongnam-si (KR); Lee Ho HWANG, Ansan-si (KR); Seong Yoon HYUN, Incheon (KR); Sang Hun PARK, Daejeon (KR); Young Hwa CHO, Ansan-si (KR); Min Ho KWAK, Suwon-si (KR); Hae Kyoon PARK, Bucheon-si (KR); Kyung Wan LIM, Siheung-si (KR); Kyeong Nam KIM, Hwaseong-si (KR); Yong Ho JUNG, Daejeon (KR)

(21) Appl. No.: 18/870,161

(22) PCT Filed: Dec. 11, 2020
(86) PCT No.: PCT/KR2020/018124

§ 371 Date: Nov. 27, 2024

(30) Foreign Application Priority Data
Oct. 30, 2020 (KR) 10-2020-0143540

(51) Int. Cl. B01D 53/86; B01D 47/06; B01D 53/26; B01J 6/00; B09B 3/50; B09B 101/70; C10B 19/00; C10B 53/02; H05H 1/26

(52) U.S. Cl. CPC B01D 53/8656; B01D 47/06; B01D 53/265; B01J 6/008; B09B 3/50; C10B 19/00; C10B 53/02; B01D 2251/11; B01D 2257/404; B01D 2257/502; B01D 2258/0283; B09B 2101/70; H05H 1/26; H05H 2245/20

(57) ABSTRACT

A batch-type complex temperature treatment machine using a high-temperature plasma, and a method for treating exhaust gas thereof. The batch-type complex temperature treatment machine using a high-temperature plasma includes: a reaction part accommodating therein organic matter for carbonization; a rotation part agitating the inside of the reaction part; and a torch part generating plasma so as to carbonize the organic matter inside the reaction part. The torch part is coupled to the reaction part and is coupled to an opposite side to the position where the organic matter is accumulated and agitated inside the reaction part.

### CROSS REFERENCE TO RELATED APPLICATIONS

This application is a National Stage Entry of International Patent Application No. PCT/KR2020/018124, filed on Dec. 11, 2020, which claims priority from and the benefit of Korean Patent Application No. 10-2020-0143540, filed on Oct. 30, 2020, each of which is hereby incorporated by reference for all purposes as if fully set forth herein.

### BACKGROUND

### Field

Embodiments of the invention relate generally relate to a batch-type complex temperature treatment machine using a high-temperature plasma, and a method for treating exhaust gas thereof, and more particularly, to a batch-type complex temperature treatment machine using a high-temperature plasma which is a batch-type treatment machine for organic matter and which is easy to maintain and economical, and a method for treating exhaust gas thereof.

### Discussion of the Background

The growth of cities and a high residential density result in a significant increase in organic substances of food waste discarded from each household. However, many bulk treatment facilities of organic substance are constructed in the outskirts of residential areas due to the “Not In My Back Yard” (NIMBY) phenomenon, and thus the organic substances are gathered in a densely constructed residential district and then transported to the organic substance treatment facilities in the outskirts for treatment. In this case, the odor or an influx of harmful insects produced during storage, transport, and final treatment of the organic substances could be another source of civil complaints, raising the awareness that food waste should be treated at respective production site by respective producer. In this respect, a technology that enables organic substances to be treated at a production site has been actively developed.

A technology for treating organic substances developed to be used in a household is a technology that shreds organic substances using a shredder and causes the shredded organic substance to flow together with water into a drain. In this technology, the treatment of the organic substance is simply performed in a household; however, many problems arise in an operation of a sewage treatment plant due to an increase in pollution load of sewage flowing into the sewage treatment plant. Further, an apparatus for destructing organic substances using a technology that performs aerobic degradation of organic substances by using microorganisms has an advantage of using an environment-friendly treatment method. However, problems or the like arise in that complete degradation of organic matters in the organic substances has to take place for a long time, continuous supply of microbe starters which are to be used corresponds to an economical burden, and many point pollution sources increase due to installation of the apparatus for destructing organic substances for each household as a malodorous substance, such as hydrogen sulfide or mercaptan, is produced while the organic matters is degraded by some anaerobic microorganisms.

On the other hand, in order to solve the above-described problems, there also has been a technology that drains effluent produced by squeezing and dehydrating organic substances to a sewer and dries or carbonizes a remaining solid using an electric heater or a fossil fuel burner. However, this technology has problems of unpleasantness in use in that a plastic bag containing the organic substances has to be opened and then only the organic substances has to be discarded, a long time of treatment by performing drying or carbonization at a temperature of 600° C. or below using an electric heater, and a significant degree of odor due to failure of high-temperature pyrolysis of malodorous substances produced during carbonization.

Recently, a method for carbonizing organic substances using a high-temperature plasma has been used, and a method for recycling gas by treating a non-biodegradable organic matter or treating and degrading the organic matter to gas by using the method for carbonizing an organic substance has been used.

A treatment apparatus for carbonizing organic substances is conventionally configured as a reactor without oxygen, in general. Regarding a temperature used therein, the low-temperature carbonization is performed at 200 to 400° C., the medium-temperature carbonization is performed at 400 to 600° C., the high-temperature carbonization is generally performed at 600° C. or above, and a method for supplying a heat source is classified by a necessary temperature range. The low-temperature carbonization is mainly performed by an indirect heating method using heating medium oil or the like, and the medium-temperature carbonization is mainly performed by a hot air blowing method. In addition, the high-temperature carbonization is performed by an indirect heating method since oxygen is required in case direct flame is to be supplied. However, an apparatus is configured in a manner that uses steam or the like as a heat source for efficiency or that uses a heat source generated during oxidation of a carbon component in a carbonization target.

A method for carbonizing or gasifying organic matters which is a treatment target by using a high-temperature plasma as a heat source uses a method of inducing oxygen to be rare by supplying N₂ rather than a vacuum state in order to induce pyrolysis in an oxygen-free atmosphere.

Further, a generally used method is a method for heating until a temperature of an overall atmosphere in a reactor reaches a desirable temperature by generating flame by attaching a plasma and supplying heat generated therefrom to a reactor.

However, energy is consumed in pre-heating, post-heating, cooling, or the like for a temperature of the atmosphere, and thus a method for using a plasma generally has a problem of high treatment costs.

In addition, there is a case where a plasma torch is provided at a lower part of a reactor in the related art, and thus moisture in organic matter infiltrates into the torch and results in an operation stop of the plasma torch in some cases. Hence, a problem arises in that organic matter inside the reactor has to be entirely removed or the like in order to perform maintenance of the plasma torch.

The above information disclosed in this Background section is only for understanding of the background of the inventive concepts, and, therefore, it may contain information that does not constitute prior art.

### SUMMARY

A batch-type complex temperature treatment machine according to embodiments of the invention is a batch-type treatment machine for organic matter which is easy to maintain and economical, and a method for treating exhaust gas thereof.

One or more embodiments of the invention include a batch-type complex temperature treatment machine using a high-temperature plasma, the machine including: a reaction part provided to accommodate therein organic matter for carbonization; a rotation part provided to agitate the inside of the reaction part; and a torch part provided to generate plasma so as to carbonize the organic matter inside the reaction part torch part is coupled to the reaction part, and is coupled to an opposite side to the position where the organic matter is accumulated and agitated inside the reaction part.

The reaction part may include: a circular or U-shaped reactor allowing organic matter to be accumulated from a bottom part; and a reaction opening provided on one side of an upper part of the reactor so as to allow organic matter to be put into the reactor and allow gas to be emitted.

The rotation part may include: a rotating shaft formed at a center of the reaction part; and a plurality of rotors coupled to the rotating shaft. The rotating shaft is provided to rotate in the same direction as a direction in which organic matter is put in through the reaction opening.

The torch part may be coupled to an upper part of the reactor to have a position and an angle so that plasma can be emitted in a direction corresponding to a direction of organic matter which is put in through the reaction opening.

The reaction opening and the torch part may be positioned in an upper left or right region of the reactor.

The torch part may be coupled in a perpendicular direction to a tangential direction of an inner wall of the reactor, and may be have an emission direction at an angle of 0° or greater inward from a tangential direction of an outer wall of the reactor.

The machine of the present invention may further include: a first heat exchange unit performing heat exchange between external air and exhaust gas exhausted from the reaction part and condense moisture of the exhaust gas; a scrubber unit connected to the first heat exchange unit and collect fine particles of the exhaust gas subjected to heat exchange; a mixing unit connected to the scrubber unit and mix oxygen with the exhaust gas subjected to collection of the fine particles; a heater unit controlling a temperature of the exhaust gas mixed with oxygen; a purification unit causing a catalytic reaction of the exhaust gas for pollution matter, the exhaust gas having a temperature controlled by the heater unit; a second heat exchange unit connected to the purification unit and condense moisture of the exhaust gas through heat exchange between the exhaust gas and the external air; and an exhaust unit provided downstream of the second heat exchange unit to discharge the exhaust gas.

The purification unit may form a bond between CO in the exhaust gas and O₂, which is additionally supplied by an oxidation catalyst, so as to form CO₂, and to change NO_{X} into N₂ and H₂O by a reduction catalyst with a reducing agent.

One or more embodiments of the invention also include a method for treating exhaust gas of the batch-type complex temperature treatment machine using a high-temperature plasma of other embodiments of the invention, the method including: a) discharging exhaust gas from the reaction part; b) performing heat exchange between external air and the discharged exhaust gas and condensing moisture by the first heat exchange unit; c) collecting fine particles of the exhaust gas subjected to condensation of moisture by the scrubber unit; d) mixing external air with the exhaust gas subjected to collection of the fine particles by the mixing unit; e) controlling a temperature of the exhaust gas mixed with oxygen by the heater unit; f) causing a catalytic reaction of the temperature-controlled exhaust gas for pollution matter by the purification unit; g) condensing moisture through heat exchange between the external air and the exhaust gas subjected to the catalytic reaction by the second heat exchange unit; and h) discharging the exhaust gas subjected to condensation of moisture by the exhaust unit.

In f), the purification unit may be provided to determine a carbonization complete state of having a moisture content of smaller than 1% in the reactor when a downstream temperature of an oxidation catalyst for a CO treatment is equal to or above a preset temperature, and to stop operation of the torch part.

Additional features of the inventive concepts will be set forth in the description which follows, and in part will be apparent from the description, or may be learned by practice of the inventive concepts.

It is to be understood that both the foregoing general description and the following detailed description are illustrative and explanatory and are intended to provide further explanation of the invention as claimed.

### BRIEF DESCRIPTION OF THE DRAWINGS

The accompanying drawings, which are included to provide a further understanding of the invention and are incorporated in and constitute a part of this specification, illustrate embodiments of the invention, and together with the description serve to explain the inventive concepts.

FIG. 1 is a diagram illustrating a configuration of a batch-type complex temperature treatment machine using a high-temperature plasma according to an embodiment of the invention.

FIG. 2 is a diagram illustrating a case in which a reactor of the batch-type complex temperature treatment machine using a high-temperature plasma is U-shaped, according to an embodiment of the invention.

FIG. 3 is a diagram illustrating a temperature for each location of the batch-type complex temperature treatment machine using a high-temperature plasma according to an embodiment of the invention.

FIG. 4A and FIG. 4B illustrate analysis tables of harmful components contained in carbonization by-products produced by a high-temperature carbonization method in the related art and a carbonization method using the batch-type complex temperature treatment machine using a high-temperature plasma according to the embodiment of the invention, respectively.

FIG. 5A and FIG. 5B illustrate tables of amounts of heavy metals produced in the reactor according to an embodiment of the invention.

FIG. 6 is a flowchart of a method for treating exhaust gas of the batch-type complex temperature treatment machine using a high-temperature plasma according to another embodiment of the invention.

FIG. 7A and FIG. 7B are graphs illustrating a change in temperature of an oxidation catalyst depending on a production amount of carbon monoxide according to an embodiment of the invention.

### DETAILED DESCRIPTION

In the following description, for the purposes of explanation, numerous specific details are set forth in order to provide a thorough understanding of various embodiments or implementations of the invention. As used herein “embodiments” and “implementations” are interchangeable words that are non-limiting examples of devices or methods employing one or more of the inventive concepts disclosed herein. It is apparent, however, that various embodiments may be practiced without these specific details or with one or more equivalent arrangements. In other instances, well-known structures and devices are shown in block diagram form in order to avoid unnecessarily obscuring various embodiments. Further, various embodiments may be different, but do not have to be exclusive. For example, specific shapes, configurations, and characteristics of an embodiment may be used or implemented in another embodiment without departing from the inventive concepts.

Unless otherwise specified, the illustrated embodiments are to be understood as providing features of varying detail of some ways in which the inventive concepts may be implemented in practice. Therefore, unless otherwise specified, the features, components, modules, layers, films, panels, regions, and/or aspects, etc. (hereinafter individually or collectively referred to as “elements”), of the various embodiments may be otherwise combined, separated, interchanged, and/or rearranged without departing from the inventive concepts.

The use of cross-hatching and/or shading in the accompanying drawings is generally provided to clarify boundaries between adjacent elements. As such, neither the presence nor the absence of cross-hatching or shading conveys or indicates any preference or requirement for particular materials, material properties, dimensions, proportions, commonalities between illustrated elements, and/or any other characteristic, attribute, property, etc., of the elements, unless specified. Further, in the accompanying drawings, the size and relative sizes of elements may be exaggerated for clarity and/or descriptive purposes. When an embodiment may be implemented differently, a specific process order may be performed differently from the described order. For example, two consecutively described processes may be performed substantially at the same time or performed in an order opposite to the described order. Also, like reference numerals denote like elements.

When an element, such as a layer, is referred to as being “on,” “connected to,” or “coupled to” another element or layer, it may be directly on, connected to, or coupled to the other element or layer or intervening elements or layers may be present. When, however, an element or layer is referred to as being “directly on,” “directly connected to,” or “directly coupled to” another element or layer, there are no intervening elements or layers present. To this end, the term “connected” may refer to physical, electrical, and/or fluid connection, with or without intervening elements.

Although the terms “first,” “second,” etc. may be used herein to describe various types of elements, these elements should not be limited by these terms. These terms are used to distinguish one element from another element. Thus, a first element discussed below could be termed a second element without departing from the teachings of the disclosure.

Spatially relative terms, such as “beneath,” “below,” “under,” “lower,” “above,” “upper,” “over,” “higher,” “side” (e.g., as in “sidewall”), and the like, may be used herein for descriptive purposes, and, thereby, to describe one elements relationship to another element(s) as illustrated in the drawings. Spatially relative terms are intended to encompass different orientations of an apparatus in use, operation, and/or manufacture in addition to the orientation depicted in the drawings. For example, if the apparatus in the drawings is turned over, elements described as “below” or “beneath” other elements or features would then be oriented “above” the other elements or features. Thus, the exemplary term “below” can encompass both an orientation of above and below. Furthermore, the apparatus may be otherwise oriented (e.g., rotated 90 degrees or at other orientations), and, as such, the spatially relative descriptors used herein interpreted accordingly.

The terminology used herein is for the purpose of describing particular embodiments and is not intended to be limiting. As used herein, the singular forms, “a,” “an,” and “the” are intended to include the plural forms as well, unless the context clearly indicates otherwise. Moreover, the terms “comprises,” “comprising,” “includes,” and/or “including,” when used in this specification, specify the presence of stated features, integers, steps, operations, elements, components, and/or groups thereof, but do not preclude the presence or addition of one or more other features, integers, steps, operations, elements, components, and/or groups thereof. It is also noted that, as used herein, the terms “substantially,” “about,” and other similar terms, are used as terms of approximation and not as terms of degree, and, as such, are utilized to account for inherent deviations in measured, calculated, and/or provided values that would be recognized by one of ordinary skill in the art.

Various embodiments are described herein with reference to sectional and/or exploded illustrations that are schematic illustrations of idealized embodiments and/or intermediate structures. As such, variations from the shapes of the illustrations as a result, for example, of manufacturing techniques and/or tolerances, are to be expected. Thus, embodiments disclosed herein should not necessarily be construed as limited to the particular illustrated shapes of regions, but are to include deviations in shapes that result from, for instance, manufacturing. In this manner, regions illustrated in the drawings may be schematic in nature and the shapes of these regions may not reflect actual shapes of regions of a device and, as such, are not necessarily intended to be limiting.

As is customary in the field, some embodiments are described and illustrated in the accompanying drawings in terms of functional blocks, units, and/or modules. Those skilled in the art will appreciate that these blocks, units, and/or modules are physically implemented by electronic (or optical) circuits, such as logic circuits, discrete components, microprocessors, hard-wired circuits, memory elements, wiring connections, and the like, which may be formed using semiconductor-based fabrication techniques or other manufacturing technologies. In the case of the blocks, units, and/or modules being implemented by microprocessors or other similar hardware, they may be programmed and controlled using software (e.g., microcode) to perform various functions discussed herein and may optionally be driven by firmware and/or software. It is also contemplated that each block, unit, and/or module may be implemented by dedicated hardware, or as a combination of dedicated hardware to perform some functions and a processor (e.g., one or more programmed microprocessors and associated circuitry) to perform other functions. Also, each block, unit, and/or module of some embodiments may be physically separated into two or more interacting and discrete blocks, units, and/or modules without departing from the scope of the inventive concepts. Further, the blocks, units, and/or modules of some embodiments may be physically combined into more complex blocks, units, and/or modules without departing from the scope of the inventive concepts.

Unless otherwise defined, all terms (including technical and scientific terms) used herein have the same meaning as commonly understood by one of ordinary skill in the art to which this disclosure is a part. Terms, such as those defined in commonly used dictionaries, should be interpreted as having a meaning that is consistent with their meaning in the context of the relevant art and should not be interpreted in an idealized or overly formal sense, unless expressly so defined herein.

Terms used in this specification are used to describe only a specific embodiment and are not intentionally used to limit the present invention thereto. A word having a singular form represents both singular and plural forms of the word unless obviously implied otherwise in context. In this specification, a term such as “to comprise” or “to include” is to be construed to specify presence of a feature, a number, a step, an operation, a configurational element, a component, or a combination thereof described in the specification and not to exclude presence or a possibility of addition of one or more other features, numbers, steps, operations, configurational elements, components, or combinations thereof in advance.

Hereinafter, embodiments of the present invention will be described in detail with reference to the accompanying drawings.

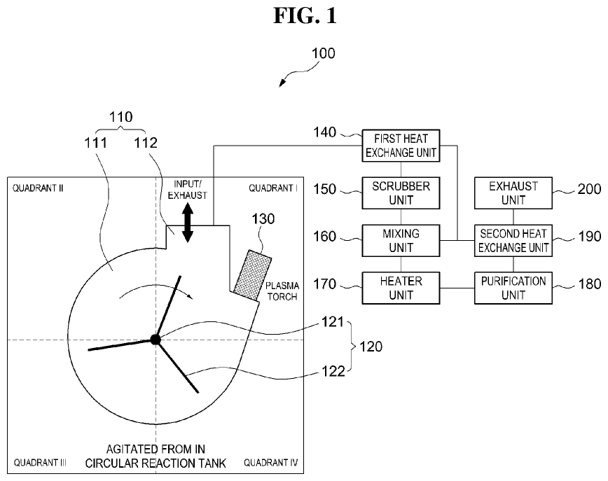

FIG. 1 is a diagram illustrating a configuration of a batch-type complex temperature treatment machine using a high-temperature plasma according to an embodiment of the invention.

With reference to FIG. 1, a batch-type complex temperature treatment machine 100 using a high-temperature plasma includes a reaction part 110, a rotation part 120, a torch part 130, a first heat exchange unit 140, a scrubber unit 150, a mixing unit 160, a heater unit 170, a purification unit 180, a second heat exchange unit 190, and an exhaust unit 200.

The reaction part 110 is provided to accommodate therein organic matter for carbonization, and includes a reactor 111 and a reaction opening 112.

The reactor 111 can be formed into a circular shape and can be provided to allow organic matter to be accumulated from a bottom part thereof. Further, the reactor 111 can be made of stainless steel so as to inhibit rust or corrosion when the organic matter is carbonized.

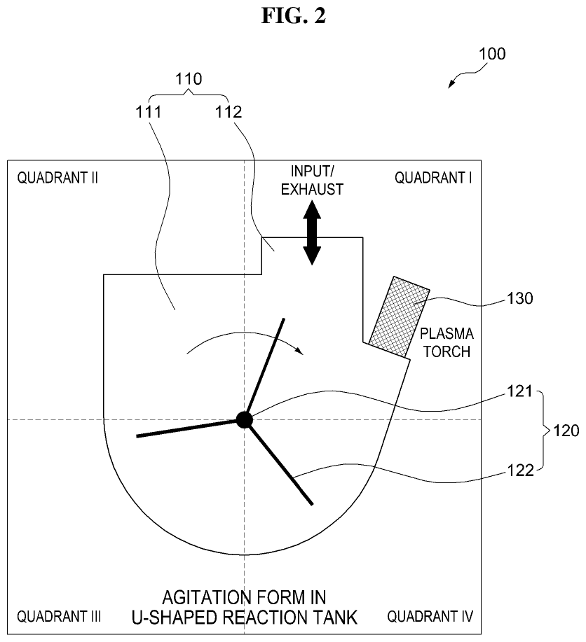

FIG. 2 is a diagram illustrating a case in which a reactor of the batch-type complex temperature treatment machine using a high-temperature plasma is U-shaped.

In addition, as illustrated in FIG. 2, the shape of the reactor 111 is not limited to a circular shape but can be a U shape or the like.

The reaction opening 112 can be provided on one side of an upper part of the reactor 111 so as to form a passage through which the organic matter can be put in the reactor.

In addition, the reaction opening 112 can be provided to discharge exhaust gas produced during carbonization of the organic matter.

In particular, as illustrated in FIG. 1, when regions of the reactor 111 are defined as quadrant I, quadrant II, quadrant III, and quadrant IV in a counterclockwise direction from an upper right side with a horizontal axis and a vertical axis as references at a center of the reactor 111, the reaction opening 112 can be formed at one of quadrant I and quadrant II.

More desirably, the reaction opening 112 can be formed at quadrant I as illustrated in the drawing.

The rotation part 120 can be provided to agitate the inside of the reaction part 110 and includes a rotating shaft 121 and rotors 122.

The rotating shaft 121 can be provided at a center of the reaction part 110 so as to be rotatable.

The rotors 122 can be coupled to the rotating shaft 121, and can be provided in plurality.

The rotating shaft 121 provided as described above can be provided to rotate in the same direction as a direction in which organic matter is put in through the reaction opening 112.

Specifically, when the reaction opening 112 is provided at quadrant I as illustrated in the drawing, the organic matter input through the reaction opening 112 is moved from quadrant I toward quadrant 4. Consequently, the rotating shaft 121 can be provided to rotate in a clockwise direction such that the rotors 122 are moved from quadrant I toward quadrant IV.

The torch part unit 130 can be provided to generate plasma so as to carbonize the organic matter inside the reaction part 110, and the torch part 130 can be coupled to the reaction part 110 and is provided to be coupled to an opposite side to the position where the organic matter is accumulated and agitated inside the reaction part 110.

Specifically, the torch part 130 can be provided to be coupled to an upper part of the reactor 111, and desirably can be provided to be positioned at a region of quadrant I on an upper right side of the reactor 111.

When the torch part 130 is positioned at a region of quadrant III and quadrant IV as a lower part of the reactor 111, the organic matter or treatment target matter put in the reactor 111 can interfere with the torch part. In particular, there is a high possibility that, in a case of organic matter containing a large amount of moisture, such as food, the plasma torch part 130 malfunctions due to infiltration of moisture into the torch part. Consequently, a phenomenon of water or moisture filling the plasma torch part 130 has to be inhibited by continuously supplying an inert gas for plasma operation from when organic matter is input to when organic matter treatment is completed.

However, when the torch part 130 is positioned at an upper part of the reactor 111 as in the invention, a problem of interference of the moisture and treatment target matter with the torch part 130 can be inhibited.

In addition, the torch part 130 can be provided to have a firing direction of flame to be the same as a direction in which the organic matter is input and a rotation direction of the rotation part 120 so as to prevent the rotation part 120 from blocking an outlet of the torch part 130.

When the rotation part 120 blocks the outlet of the torch part 130, it is not only affected by moisture but also in reactivity. The organic matter is induced to be carbonized; however, the organic matter can be gasified by being left at a high temperature for a long time. This leads to a reaction which does not correspond to the object to be achieved.

In addition, when the plasma torch is positioned at a lower part, maintenance of the plasma torch is difficult if the content in the reactor 111 is not removed during maintenance thereof. However, the torch part 130 positioned at an upper part forms a structure in which attachment and detachment and maintenance thereof can be performed without removing the content in the reactor 111.

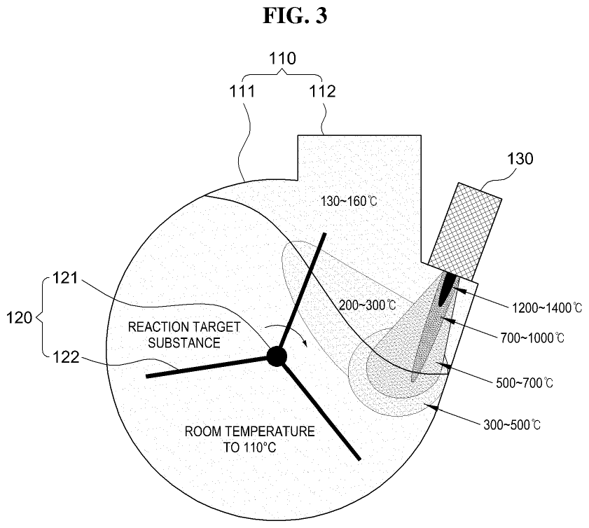

FIG. 3 is a diagram illustrating a temperature for each location of the batch-type complex temperature treatment machine using a high-temperature plasma according to an embodiment of the invention.

With reference to FIG. 3, a low-temperature, medium-temperature, or high-temperature carbonization method is generally used as a method for carbonizing organic matter.

A plasma flame has a temperature of about 1,400° C. or above at a central portion, and the temperature is rapidly lowered as the plasma flame is released into the atmosphere. In this case, dry-carbonization-gasification steps can be induced depending on how long a reaction target object is maintained in a temperature range. In addition, the low-temperature carbonization results in an increase in calorific value due to remaining organic matter in addition to carbon, and thus, can be advantageous in that the remaining organic matter can be used as nutriment for plants when used in soil, and can be used as slow-release nutriment.

In the case of the low-temperature carbonization, a large amount of cellulose and lignin is present, and a pH of about 6 to 7 is maintained. However, the high-temperature carbonization leaves mostly carbon components only, increasing substances to be oxidized so as to increase the number of batches and increasing pH to 9 or higher so as to result in an adverse effect when a large amount is used, and thus nutrients, the calorific value, or the like decreases to a certain extent.

The medium-temperature carbonization is performed at a temperature of about 400° C. In this case, harmful dioxins can be produced, and carbonization by-products can be produced by an oil component such as tar.

When the torch part 130 configured as a DC high-temperature plasma generating apparatus discharging plasma from quadrant I of the reactor 111, as illustrated in FIG. 3, various temperature regions are formed in the reactor 111. In this case, the carbonization proceeds similar to carbonization after drying which is a general carbonization process. However, some low-temperature carbonization is performed even in a drying period in this apparatus, and a high-temperature carbide is rapidly formed when a moisture content reaches 5% or less.

Specifically, even though some locations have a temperature for the medium-temperature carbonization, the locations correspond to some surface of a carbonization target object, and the remaining organic matter decreases in temperature to a low temperature due to heat transmission through agitation and a large amount of moisture. Further, as moisture is vaporized, heat of vaporization is taken from the organic matter such that the temperature of the organic matter does not rapidly increase. In this case, a phenomenon of the low-temperature carbonization occurs at a surface at which the medium-temperature carbonization can occur. When agitation is not performed or moisture is not present, a large amount gasification is to be performed as very rapid high-temperature carbonization occurs. The invention ensures economic efficiency of consumed energy by minimizing the amount of gasification only as much as necessary for carbonization and can perform the carbonization by adjusting an agitation speed of the rotation part 120 so as to minimize the amount of gasification.

As described above, the machine is characterized by feasibility of all of desired low-temperature, medium-temperature, high-temperature carbonizations by using the rotation part 120 and the torch part 130.

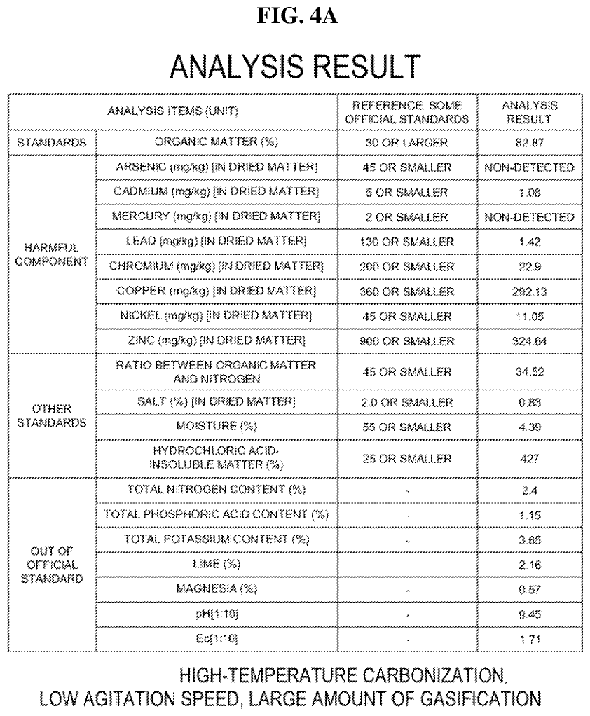

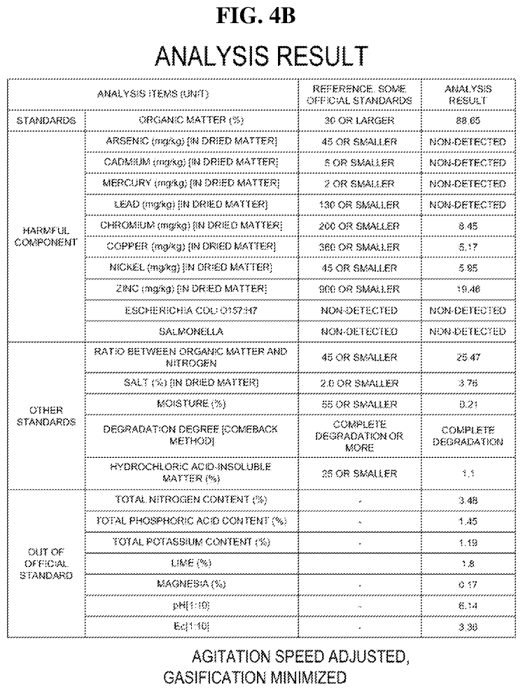

FIGS. 4A and 4B illustrate analysis tables of harmful components contained in carbonization by-products produced by a high-temperature carbonization method in the related art and a carbonization method using the batch-type complex temperature treatment machine using a high-temperature plasma, respectively, according to the embodiment of the invention, respectively.

FIG. 4A shows results of content analysis of harmful components after the gasification is significantly performed by slowing the agitation speed so as to perform the high-temperature carbonization.

FIG. 4B shows results of content analysis of harmful components, after the low-temperature carbonization, in which the agitation speed is adjusted and gasification is minimized, is performed.

With reference to FIGS. 4A and 4B, dried matter of the organic matter or carbides generally have a calorific value of about 3,500 to 4,000 kcal/kg. Hence, general dried matter contains about 10% of moisture to lower the calorific value. In addition, since a component that can generate heat is gasified and removed depending on a carbonization degree, the calorific value is affected to be lowered. In order to induce a calorific value characteristic of 4,500 kcal/kg or higher, which is a calorific value of the general low-temperature carbides, the carbonization has to be performed at a low temperature. However, in this case, the percentage of moisture content is difficult to induce to a very low percentage of 1% or lower, and the low-temperature carbonization alone does not remove an odor component or the like present in a carbonization target substance. Hence, carbides having some shortcomings when used in soil are produced.

Carbides of organic matter such as foods, pear, or citron have a calorific value of 5,000 kcal/kg or higher by using the complex temperature treatment machine. However, when waste fruits or food waste is treated in accordance with the invention as illustrated in FIGS. 4A and 4B, the carbides do not have a brown color of the low-temperature carbides but have a black carbide shape of the high-temperature carbides. In other words, the carbides having properties of the low-temperature carbides having a high calorific value are produced when carbonization is performed by complex reactions (at a high temperature and at a low temperature).

As described above, the invention can have an effect of degrading a harmful component, odor gas, or the like which is an advantage of the high-temperature carbonization while maintaining of the calorific value, the nutrient, or the like of the carbides, which is an advantage of the low-temperature carbonization, is achieved.

The torch part 130 can be coupled to the reactor 111 to have a position and an angle so that plasma can be emitted in a direction corresponding to a direction of organic matter which is put in through the reaction opening 112.

More specifically, the torch part 130 can be coupled in a perpendicular direction to a tangential direction of an inner wall of the reactor 111 and can be provided to have an emission direction at an angle of 0° or larger inward from a tangential direction of an outer wall of the reactor 111.

Specifically, a general carbonization reactor made of a general steel material is rusted and corroded due to a large amount of moisture. Hence, as described above, the reactor 111 of the invention is made of a stainless steel material so as to inhibit rust or corrosion.

However, in a case of using the high-temperature plasma having an ultra high temperature, a harmful component such as nickel or chromium can be emitted from the stainless steel material in a high-temperature region.

The invention reduces emission of a harmful substance which can be produced through pyrolysis of the material of the reactor 111 with the organic matter put inside the reactor, the agitation speed, or a shape of the reactor 111.

More specifically, a temperature inside the reactor varies depending on the agitation speed or a position of the plasma torch part 130. In addition, an internal temperature varies depending on presence or absence of organic matter therein.

Consequently, the torch part 130 can be coupled in the perpendicular direction to the tangential direction of the inner wall of the reactor 111 and can be provided to have the emission direction at an angle of 0° or greater inward from the tangential direction of the outer wall of the reactor 111, and therefore the torch part 130 can have a structure in which the organic matter absorbs ultra-high-temperature heat generated from the plasma torch by rotation of the internal rotation part 120 in the reactor 111 such that the outer wall of the reactor 111 is not affected.

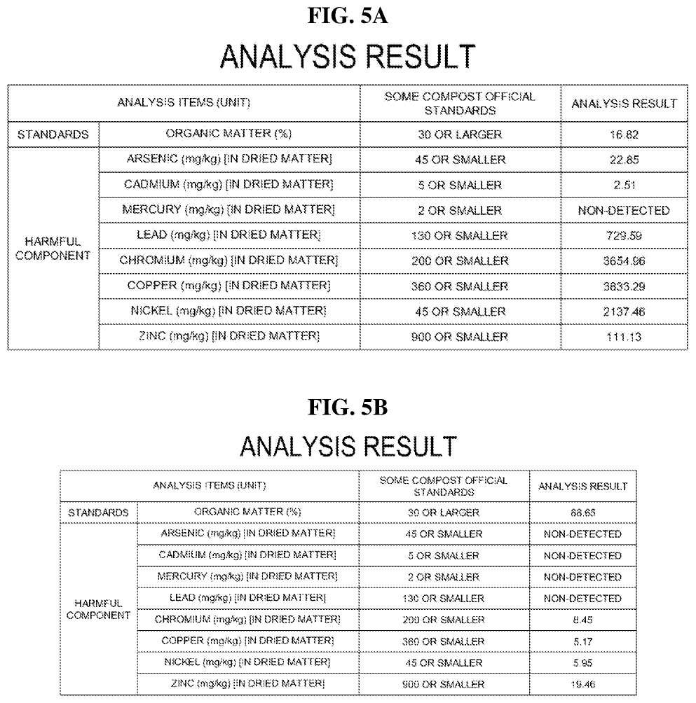

FIGS. 5A and 5B illustrate tables of amounts of heavy metals produced in the reactor according to the embodiment of the invention.

With reference to FIGS. 5A and 5B, in a case of disposition as described above, the amount of a heavy metal component such as chromium which is separated from the inside of the reactor 111 made of stainless steel can be minimized.

In addition, regarding a direction of the rotation part 120, when the rotation part 120 rotates toward the plasma torch part 130, a reaction target substance blocks a plasma flame in front of the plasma torch, and the plasma flame is bent toward the outer wall of the reactor 111. In this case, a harmful heavy metal is separated from the stainless steel instantaneously due to a high temperature of 1,200° C. or greater and is mixed with the reaction target substance to produce harmful substances. In addition, a durable degree of the reactor is lowered, and durability is lowered.

However, in the invention, in order to manufacture the reactor 111 made of the stainless steel material, the plasma torch part 130 is positioned at an upper part of the reactor 111 and is attached in the perpendicular direction to the tangential direction of the inner wall of the reactor 111. In addition, since the plasma torch part 130 can be provided at the angle of 0° or greater inward from the tangential direction of the outer wall, and the direction of the rotation part 120 is maintained in the same direction as the direction of the plasma flame, the amount of a heavy metal component separated inside the reactor 111 can be minimized.

The first heat exchange unit 140 can be provided to perform heat exchange between external air and exhaust gas discharged from the reaction part 110 and condense moisture of the exhaust gas.

In the beginning of the gas treatment during carbonization, moisture to be vaporized, fine carbonized powder, and the like is mostly produced and is emitted by being gasified into a form of CO and nitrogen oxide such as NO_{X} when the amount of moisture is minimized to about 5% or less.

The first heat exchange unit 140 can be provided to allow external air to directly flow therein or can be provided to be connected to the second heat exchange unit 190 so as to allow external air subjected to heat exchange once to flow therein. As described above, the first heat exchange unit 140 can be provided to condense moisture in the exhaust gas by using the flowing-in external air as cooling energy.

The scrubber unit 150 can be provided to be connected to the first heat exchange unit 140 and collect fine particles of the exhaust gas subjected to the heat exchange.

The scrubber unit 150 can be configured of a water spray scrubber and can be provided to collect fine particles and remove condensed moisture.

The exhaust gas passing through the first heat exchange unit 140 and the scrubber unit 150 as described above remains only as synthesis gas such as H₂, CO, or NO_{X}.

The mixing unit 160 can be provided to be connected to the scrubber unit 150 and mix oxygen with the exhaust gas subjected to collection of the fine particles.

Specifically, the exhaust gas produced in the anaerobic reaction part 110 very much lacks an oxygen component. Consequently, since oxygen is additionally required during a catalytic reaction with an oxidation catalyst in the purification unit 180, the mixing unit 160 can be provided to receive external air from the second heat exchange unit 190 and mix the external air with the exhaust gas.

The heater unit 170 can be provided to control a temperature of the exhaust gas mixed with oxygen.

The catalytic reaction in the purification unit 180 requires an appropriate temperature to be activated. Consequently, the heater unit 170 can be configured as an indirect contact heater to perform control such that the exhaust gas flowing to the purification unit 180 is not oxidized but has a temperature suitable for the catalytic reaction.

The purification unit 180 can be provided to cause the catalytic reaction of the exhaust gas for pollution matter, the exhaust gas having a temperature controlled by the heater unit 170.

Specifically, the purification unit 180 can be provided to form a bond between CO in the exhaust gas and O₂, which is additionally supplied by an oxidation catalyst, so as to form CO₂, and to change NO_{X} into N₂ and H₂O by the reduction catalyst with a reducing agent.

As described above, the purification unit 180 can be provided to change the pollution matter into unharmful gas through the catalytic reaction.

The second heat exchange unit 190 can be provided to be connected to the purification unit 180 and condense moisture of the exhaust gas through the heat exchange between the exhaust gas and the external air. Further, the external air increased in temperature can be supplied upstream of the heater unit 170 so as to help energy consumption of a heater.

The exhaust unit 200 can be provided downstream of the second heat exchange unit 190 and discharge the exhaust gas consisting of unharmful gas.

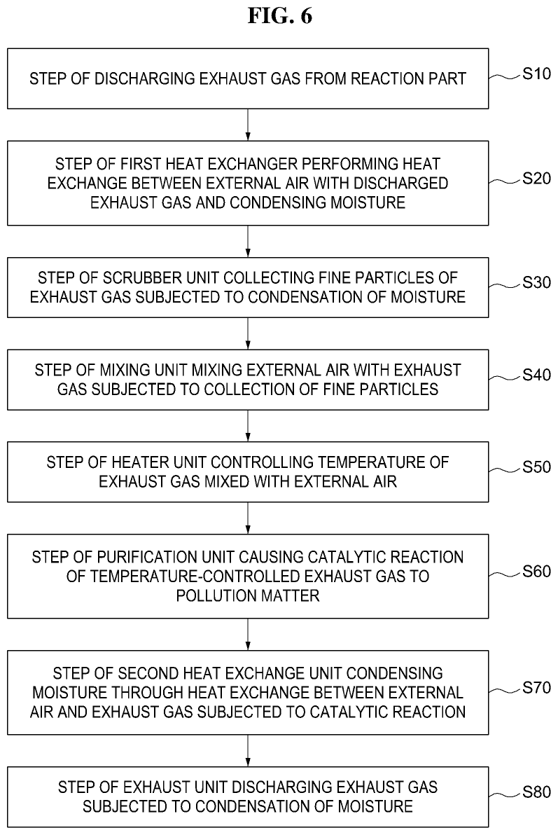

FIG. 6 is a flowchart of a method for treating exhaust gas of the batch-type complex temperature treatment machine using a high-temperature plasma according to another embodiment of the invention.

With reference to FIG. 6, in the method for treating exhaust gas of the batch-type complex temperature treatment machine using a high-temperature plasma, Step S10 of discharging the exhaust gas from the reaction part can be first performed.

In Step S10 of discharging the exhaust gas from the reaction part, the exhaust gas produced from the carbonization in the reaction part 110 can be discharged toward the first heat exchange unit 140.

After Step S10 of discharging the exhaust gas from the reaction part, Step S20 of performing heat exchange between external air and the discharged exhaust gas and condensing moisture can be performed by the first heat exchange unit.

In Step S20 of performing heat exchange between external air and the discharged exhaust gas and condensing moisture by the first heat exchange unit, the first heat exchange unit 140 can be provided to perform the heat exchange between the discharged exhaust gas and the external air so as to condense and remove the moisture.

After Step S20 of the first heat exchange unit performing heat exchange between external air and the discharged exhaust gas and condensing moisture, Step S30 of collecting fine particles of the exhaust gas subjected to condensation of moisture can be performed by the scrubber unit.

In Step S30 of the scrubber unit collecting fine particles of the exhaust gas subjected to condensation of moisture, the scrubber unit 150 can be configured of a water spray scrubber and can remove fine particles and moisture in the exhaust gas.

After Step S30 of the scrubber unit collecting fine particles of the exhaust gas subjected to condensation of moisture, Step S40 of mixing the external air with the exhaust gas subjected to collection of fine particles can be performed by the mixing unit.

In Step S40 of the mixing unit mixing the external air with the exhaust gas subjected to collection of fine particles, the mixing unit 160 can be provided to be connected to the scrubber unit 150 and mix oxygen with the exhaust gas subjected to the collection of fine particles.

After Step S40 of the mixing unit mixing the external air with the exhaust gas subjected to collection of fine particles, Step S50 of controlling a temperature of the exhaust gas mixed with the external air can be performed by the heater unit.

In Step S50 of the heater unit controlling a temperature of the exhaust gas mixed with the external air, the heater unit 170 can perform control such that the exhaust gas flowing to the purification unit 180 is not oxidized but has a temperature suitable for the catalytic reaction.

After Step S50 of the heater unit controlling a temperature of the exhaust gas mixed with the external air, Step S60 of causing a catalytic reaction of the temperature-controlled exhaust gas for pollution matter can be performed by the purification unit.

In Step S60 of the purification unit causing a catalytic reaction of the temperature-controlled exhaust gas for pollution matter, the purification unit 180 can be provided to cause the catalytic reaction of the exhaust gas for pollution matter, the exhaust gas having a temperature controlled by the heater unit 170.

Specifically, the purification unit 180 can be provided to form a bond between CO in the exhaust gas and O₂, which is additionally supplied by an oxidation catalyst, so as to form CO₂, and to change NO_{X} into N₂ and H₂O by the reduction catalyst with a reducing agent.

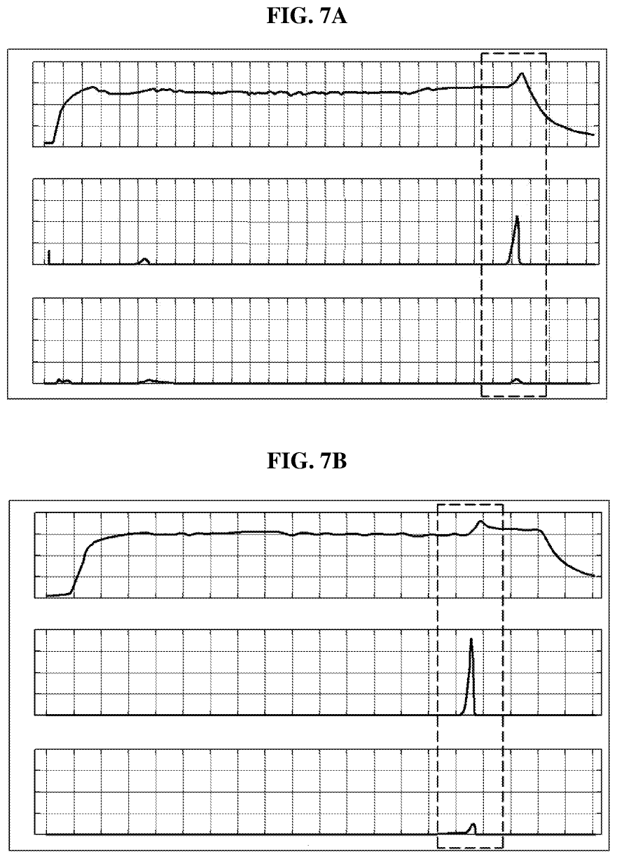

FIGS. 7A and 7B are graphs illustrating a change in temperature of an oxidation catalyst depending on a production amount of carbon monoxide according to an embodiment of the invention.

With reference to FIGS. 7A and 7B, in Step S60 of the purification unit causing a catalytic reaction of the temperature-controlled exhaust gas for pollution matter, the purification unit 180 can be provided to determine a carbonization complete state of having a moisture content of less than 1% in the reactor when a downstream temperature of an oxidation catalyst for a CO treatment is equal to or above a preset temperature, and to stop operation of the torch part 130.

Specifically, in the operation of the batch-type complex temperature treatment machine using a high-temperature plasma, a configuration of a service end time (carbonization complete step) is important. More treatment than needed results in excessive energy consumption and requires more capacity than needed of a configuration of exhaust gas treating equipment.

In addition, untreated matter causes insufficient carbonization, degrades quality of by-products to be used later, and results in malfunction of a discharge system.

When the moisture content of organic matter put in the reaction part 110 becomes about 1% or smaller, supplied energy is not mainly used for moisture vaporization but is used to gasify the organic matter. In this case, CO is synthesized and produced. Further, a CO treatment catalyst causes an oxidation reaction, and heat is generated. Consequently, without an additional gas measuring sensor, the amount of gas production can be calculated using a downstream temperature of a CO catalyst, and heat generated at equal to or more than a certain level based on the calculated amount of gas is recognized as a state of having a moisture content of 1% or less content or a carbonization complete state. In this case, the operation of the torch part 130 and the operation of the batch-type complex temperature treatment machine 100 using a high-temperature plasma can be ended.

After Step S60 of the purification unit causing a catalytic reaction of the temperature-controlled exhaust gas for pollution matter, Step S70 of performing heat exchange between external air and exhaust gas subjected to a catalytic reaction and condensing moisture can be performed by the second heat exchange unit.

In Step S70 of the second heat exchange unit performing heat exchange between external air and exhaust gas subjected to a catalytic reaction and condensing moisture, the second heat exchange unit 190 can be provided to be connected to the purification unit 180 and condense moisture of the exhaust gas through the heat exchange between the exhaust gas and the external air. Further, the external air increased in temperature can be supplied upstream of the heater unit 170 so as to help energy consumption of a heater.

After Step S70 of the second heat exchange unit performing heat exchange between external air and exhaust gas subjected to a catalytic reaction and condensing moisture, Step S80 of discharging the exhaust gas subjected to condensation of moisture can be performed by the exhaust unit.

In Step S80 of the exhaust unit discharging the exhaust gas subjected to condensation of moisture, the exhaust unit 200 can be provided to discharge the exhaust gas consisting of unharmful gas.

In the present invention, the batch-type complex temperature treatment machine can be a carbonizing machine.

The present invention according to the above-described configurations is economically effective in that a carbonization degree of organic matter is derived from a downstream temperature of an oxidation catalyst for treatment of carbon monoxide and a service end time of a plasma torch part can be determined without an additional gas measuring system.

In addition, the plasma torch part is provided at an upper part of a reactor, and thus a problem of moisture infiltrating into the torch part does not arise. Thus, there is no need to remove content in the reactor, making maintenance of the torch part easy.

In addition, since the torch part is positioned at an upper right part and discharges plasma, various temperature regions can be formed in the reactor and enables carbonization to be performed depending on complex temperatures of a high temperature, a medium temperature, and a low temperature.

In addition, although the reactor is made of stainless steel, a temperature in the reactor is below 150° C., so no harmful substances are produced by the plasma.

In addition, according to the present invention, an internal temperature of the reactor can be maintained mostly at the lowest temperature (100° C. due to necessity of vaporization) by using a plasma having various temperatures from partially high temperature (1,500° C. or above) to a low temperature. Consequently, minimum gasification for carbonization is induced, and thereby safety of equipment is improved with low overall treatment temperature and pressure and the gasification for carbonization can be minimized to an extent as much as necessary such that an economical operation can be performed.

Although certain embodiments and implementations have been described herein, other embodiments and modifications will be apparent from this description. Accordingly, the inventive concepts are not limited to such embodiments, but rather to the broader scope of the appended claims and various obvious modifications and equivalent arrangements as would be apparent to a person of ordinary skill in the art.

1. A batch-type complex temperature treatment machine using a high-temperature plasma, comprising:
a reaction part configured to accommodate therein organic matter for carbonization;
a rotation part configured to agitate the inside the reaction part; and
a torch part configured to generate plasma so as to carbonize the organic matter inside the reaction part,
wherein the torch part is coupled to the reaction part, and is coupled to an opposite side to the position where the organic matter is accumulated and agitated inside the reaction part

2. The batch-type complex temperature treatment machine using a high-temperature plasma according to claim 1, wherein the reaction part includes:
a circular or U-shaped reactor configured to allow organic matter to be accumulated from a bottom part; and
a reaction opening arranged on one side of an upper part of the reactor so as to allow organic matter to be put into the reactor and allow gas to be emitted.

3. The batch-type complex temperature treatment machine using a high-temperature plasma according to claim 1, wherein:
the rotation part includes:
a rotating shaft formed at a center of the reaction part; and
a plurality of rotors coupled to the rotating shaft; and
the rotating shaft is configured to rotate in the same direction as a direction in which organic matter is put in through the reaction opening.

4. The batch-type complex temperature treatment machine using a high-temperature plasma according to claim 2,
wherein the torch part is coupled to an upper part of the reactor to have a position and an angle so that plasma can be emitted in a direction corresponding to a direction of organic matter which is put in through the reaction opening.

5. The batch-type complex temperature treatment machine using a high-temperature plasma according to claim 4,
wherein the reaction opening and the torch part are positioned in an upper left region or upper right region of the reactor.

6. The batch-type complex temperature treatment machine using a high-temperature plasma according to claim 4,
wherein the torch part is coupled in a perpendicular direction to a tangential direction of an inner wall of the reactor, and has an emission direction at an angle of 0° or larger inward from a tangential direction of an outer wall of the reactor.

7. The batch-type complex temperature treatment machine using a high-temperature plasma according to claim 1, further comprising:
a first heat exchange unit configured to perform heat exchange between external air and exhaust gas discharged from the reaction part and condense moisture of the exhaust gas;
a scrubber unit connected to the first heat exchange unit and configured to collect fine particles of the exhaust gas subjected to heat exchange;
a mixing unit connected to the scrubber unit and configured to mix oxygen with the exhaust gas subjected to collection of the fine particles;
a heater unit configured to control a temperature of the exhaust gas mixed with oxygen;
a purification unit configured to cause a catalytic reaction of the exhaust gas for pollution matter, the exhaust gas having a temperature controlled by the heater unit;
a second heat exchange unit connected to the purification unit and configured to condense moisture of the exhaust gas through heat exchange between the exhaust gas and the external air; and
an exhaust unit arranged downstream of the second heat exchange unit to discharge the exhaust gas.

8. The batch-type complex temperature treatment machine using a high-temperature plasma according to claim 7,
wherein the purification unit is configured to make a bond between CO in the exhaust gas and O₂, which is additionally supplied by an oxidation catalyst, so as to form CO₂, and to change NO_{X} into N₂ and H₂O by a reduction catalyst with a reducing agent.

9. A method for treating exhaust gas of the batch-type complex temperature treatment machine using a high-temperature plasma according to claim 7, the method comprising:
a) discharging exhaust gas from the reaction part;
b) performing heat exchange between external air and the discharged exhaust gas and condensing moisture by the first heat exchange unit;
c) collecting fine particles of the exhaust gas subjected to condensation of moisture by the scrubber unit;
d) mixing external air with the exhaust gas subjected to collection of the fine particles by the mixing unit;
e) controlling a temperature of the exhaust gas mixed with oxygen by the heater unit;
f) causing a catalytic reaction of the temperature-controlled exhaust gas to pollution matter by the purification unit;
g) condensing moisture through heat exchange between the external air and the exhaust gas subjected to the catalytic reaction by the second heat exchange unit; and
h) discharging the exhaust gas subjected to condensation of moisture by the discharge unit.

10. The method for treating exhaust gas of the batch-type complex temperature treatment machine using a high-temperature plasma according to claim 9,
wherein, in the step of f), the purification unit is configured to determine a carbonization complete state of having a moisture content less than 1% in the reactor when a downstream temperature of an oxidation catalyst for a CO treatment is equal to or greater than a preset temperature, and to stop operation of the torch part.
